(19) United States
(12) Patent Application Publication
(10) Pub. No.: US 2025/0022619 A1
(43) Pub. Date: Jan. 16, 2025

(54) DEVICE AND PROCESS FOR GENERATING HEAT ENERGY USING LOW-ENERGY NUCLEAR REACTION

(71) Applicant: ECOENGINEERING DR. WINZELER, Winterthur (CH)

(72) Inventor: Heinz Beat WINZELER, Winterthur (CH)

(73) Assignee: ECOENGINEERING DR. WINZELER, Winterthur (CH)

(21) Appl. No.: 18/713,636

(22) PCT Filed: Nov. 25, 2021
(86) PCT No.: PCT/EP2021/083053

§ 371 Date: May 24, 2024

(51) Int. Cl. G21B 3/00

(52) U.S. Cl. CPC G21B 3/00

(57) ABSTRACT

A device for obtaining thermal energy by means of a low-energy nuclear reaction includes a tubular reactor that is configured to receive a metallic reaction material and inductively heat the reaction material, the reactor having an electrically insulating and induction-permeable material. The device further includes a closure that can be sealed in a vacuum-tight manner and configured to allow introduction and exchange of different metallic reaction materials, a gas exchange connection for evacuation and introduction of reaction gas, one or more sensors to measure temperature or pressure in an interior of the reactor, and an inductor for generating an alternating magnetic field in the interior of the reactor. The reaction material can be inductively heated by applying an alternating voltage to the inductor, the closure, and the gas exchange connection.

### CROSS REFERENCE TO RELATED APPLICATION

The present application claims the priority benefits of International Patent Application No. PCT/EP2021/083053, filed on Nov. 25, 2021, which is hereby incorporated herein by reference in its entirety.

### FIELD OF THE INVENTION

The present invention relates to an apparatus, its use and a method for generating thermal energy, in particular by a low-energy nuclear reaction.

### BACKGROUND OF THE INVENTION

In distinction to the historical term “cold fusion”, such reactions, which can occur in metal-hydrogen systems near room temperature, are referred to as “Low Energy Nuclear Reactions”, abbreviated LENR, but also as “Chemically Assisted Nuclear Reactions” with the abbreviation CANR. They typically take place on heated metal grids in the presence of hydrogen under conditions that are much milder than those in a nuclear fusion or fission reactor. No nuclear chain reactions take place and no radioactive waste is produced. Therefore, low-energy nuclear reactions can be carried out and handled in much simpler facilities. Above all, there is incomparably less, or practically no potential danger. They therefore represent a potentially very promising, environmentally friendly as well as cost-effective energy source as an advantageous alternative to the nuclear energy technology currently used for energy production.

Even decades after its discovery, the phenomenon is still little researched. It is assigned to the research field “Condensed Matter Nuclear Physics”. Over the years, various theories have been developed for the low-energy nuclear reactions that are within the standard model of physics. The best known is the theory of A. Widom and L. Larsen (Widom, A; Larsen, L. “Ultra Low Momentum Neutron Catalyzed Nuclear Reactions on Metallic Hydride Surfaces”. The European Physical Journal C. 46 (1): 107, April 2006). It explains why neither radioactive radiation nor radioactive elements occur in this type of nuclear reaction, and why overcoming the Coulomb barrier-unlike in nuclear fusion—is not important. Today, there is a broad consensus that the weak interaction (also called “weak nuclear force”) and beta decay form the basis of low-energy nuclear reactions, but not fusion processes. A study by David J. Nagel compares different approaches: Expectations of LENR Theories, 12th Int. Workshop on Anomalies in Hydrogen loaded Metals, IT-14055 Costigliole d,Asti IT, (June 2017). Reference is made to a publication in Nature on low-energy nuclear reactions (Berlinguette, Curtis P., Yet-Ming Chiang, Jeremy N. Munday, Thomas Schenkel, David K. Fork, Ross Koningstein, and Matthew D. Trevithick: “Revisiting the Cold Case of Cold Fusion”, Nature, 570 (7759): 45-51, (06.2019);

https://doi.org/10.1038/s41586-019-1256-6).

A distinction is typically made between three methods of generating excess heat:
Electrodes (usually made of Ni or Pd) are charged with high concentrations of hydrogen (protium or deuterium) by means of electrolysis;
Metals (e.g. metal powder) are heated in hydrogen environment at approx. 450-1700 K;
pulsed plasma discharges.

The present invention relates to the second method (heating metals in a hydrogen environment).

Conventionally, apparatuses for generating and utilizing LENR excess heat are resistively heated with direct or alternating current (single or three-phase). As a rule, these are heated by means of heating wire windings, usually made of constantan or with heat carriers. The heat is dissipated either by heat carriers, by their evaporation, by convection and/or by radiation onto a heat exchange surface. Electrical pulses, pressure changes or temperature jumps are generated to stimulate the reaction. In contrast, inductive heating and stimulation have not yet been applied or published. The construction of apparatuses described so far is usually complex and the exchange of reaction material is cumbersome, if possible at all. Heating by resistance windings is less efficient than inductive heating. In contrast, inductive or microwave-based heating and stimulation has neither been applied nor published in connection with low-energy nuclear reaction. A large number of described apparatuses serve to observe and measure excess heat, but do not sufficiently show how the thermal energy is to be extracted for use. In many cases, these are disposable devices (such as Parkomow, glowstick, etc.). The measurement of internal temperatures is only possible at previously fixed points in the devices described so far. In addition, the seals and sensor connections are usually exposed to higher temperatures and temperature changes. In the majority of cases, expensive reagents such as palladium and deuterium are used (e.g. Mosier-Boss, Pamela A., Lawrence P. Forsley, and Patrick K. McDaniel: “Investigations of nano-nuclear reactions in condensed matter—final report”; Defence Treat Reduction Agency DTRA, 2016) https://doi.org/10.13140/RG.2.2.31859.53282. Far less expensive is the generation of heat effects in metals such as nickel and inexpensively available hydrogen, which Francesco Piantelli discovered as early as 1989. (Focardi, S., V. Gabbani, Vera Montalbano, Piantelli Francesco, and Stefano Veronesi: “Large excess heat production in Ni—H systems”. Il Nuovo Cimento A 111, November 1998).

### SUMMARY OF THE INVENTION

Apparatus for obtaining thermal energy by means of a low-energy nuclear reaction, comprising a reactor which can be sealed in a vacuum-tight manner and has a metallic reaction material which is arranged annularly in the reactor and is inductively heated and stimulated by an alternating magnetic field. In a first embodiment, the inductor, which is designed as a tubular coil, also serves as a heat dissipation device. In a second embodiment, the heat exchange is taken over by a dynamic insulation consisting of an open-pored insulating material through which a heat transfer fluid flows from the outside towards the inside, which absorbs and dissipates the heat radiated from the reactor core in counter current practically without loss. The reactor closure allows the introduction and replacement of reaction material of different shapes and contains feed-throughs for sensors (temperatures, pressure) and a gas exchange (vacuum, reaction gas). The temperature sensors are freely movable in a central tube. The closure seal and the feedthroughs are thermally insulated from the reaction zone and thus not exposed to temperature changes.

### BRIEF DESCRIPTION OF THE DRAWINGS

Further details of the invention with examples of embodiments of the device according to the invention and its use are described below with reference to the accompanying drawings. FIGS. 1 to 6 show the device according to the invention and individual components of this device. The various embodiments can be combined with each other in any desired way, as far as this makes sense.

FIG. 1 shows a schematic sectional view of a reactor according to a first embodiment of the invention, in which a reaction material 2 is arranged. This is positioned by non-conductive spacer rings 3. A thermally insulating material 3 serving as a convection brake reduces the gas volume and protects seals and connections from high temperatures and temperature changes. This can also be designed as a hollow body.

FIG. 2 shows a schematic view of an inductor of the device according to the first embodiment of the invention, which also serves as a heat dissipation device.

FIG. 3 shows a schematic sectional view of the reaction material of the device according to the invention as a ring stack (2a) and as powder (2b) introduced hollow-cylindrically in an annular gap.

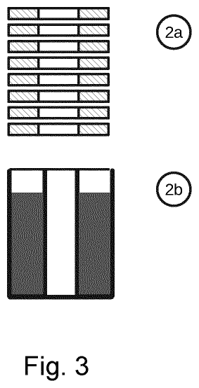

FIG. 4 shows a sectional view of the device with an inductor (11a) according to the first embodiment. The thermal insulation is indicated as a conventional (static) design (12a).

FIG. 5 shows a schematic sectional view of a reactor and an inductor of a device according to a second embodiment. Here, the thermal insulation (12b) according to the second embodiment example of the invention is designed as dynamic insulation and device for heat dissipation. A carrier gas, for example air, is conveyed by a blower (15) into the external chamber and from there through the insulation layer (13). The heat absorbed in the insulation layer is dissipated via the collector (12b). The inductor (11b) can be a solid material, for example a copper conductor. In this form, it is not used for heat dissipation at the same time.

FIG. 6 shows a schematic view of the device as a P&I diagram with the necessary piping and signal lines, as well as measuring, regulating and control instruments.

### DESCRIPTION OF THE PREFERRED EMBODIMENTS

An underlying problem of the present invention is to provide an improved solution for a cheaper and more efficient thermal energy production, which can be manufactured in modular units, in particular on a micro to industrial scale.

This task is solved by a device according to claim 1, the use according to claim 13 and a method according to claim 14. Further embodiments of the invention are indicated in the subclaims. The features mentioned in the subclaims and the description for the device according to the invention can also be understood as a further developments of the method according to the invention.

The device according to the invention and the associated process are intended to generate thermal energy, in particular in the form of excess heat, which is released during a low-energy nuclear reaction at the metal lattice of the reaction material heated under hydrogen. Preferably, the reactor vessel is vacuum-tight and reversibly closable. The reactor may have separately closable ports for the supply of a reaction gas and for evacuation, or may have multiple ports. One or more temperature sensors are preferably led into the reactor under ambient pressure through a tube which is closed towards the inside and open towards the outside, and can be freely positioned axially, in particular during operation.

The device comprises a reaction material arranged in the reactor, which contains a metal or consists of a metal. Pretreatment of the material is highly recommended to increase the effectiveness. The corresponding procedure is described below. Preferably, the reaction material has a ring shape, since such a shape is advantageous with respect to inductive heating. The material may be present as a stack of rings or as a powder in an annular gap.

The inductive heating consists in particular of a coil surrounding the reactor and a power oscillator for generating an alternating magnetic field inside the reactor. In this context, the reaction material and the inductor are preferably designed and arranged in such a way that the reaction material can be inductively heated and stimulated in an effective manner by applying an alternating voltage to the inductor, so that a low-energy nuclear reaction can be initiated and maintained.

Preferably, the device according to the invention further comprises a heat transport system for removing thermal energy emitted by the reactor. This may be implemented in two different variants. In a first example of use, the inductor coil comprises a metal tube, for example of copper and/or aluminium, which simultaneously absorbs and carries away the heat of reaction. In a second application example, the inductor winding can consist of solid material. This is then surrounded by a dynamic insulation. This consists of fluid-permeable material through which a heat transfer fluid is conveyed from the outside towards the inside in the opposite direction to the generated heat flow, whereby the heat transfer fluid carries away the heat from the reaction area. The principle is described below.

The inductor coil can be designed as a corrugated tube and/or with fins to increase the heat exchange surface. The reaction gas used is in particular hydrogen or a hydrogen-containing gas mixture, for example consisting of a hydrogen component and a noble gas component. “Hydrogen” is understood to mean the hydrogen isotopes protium (1H) and deuterium (2H).

Preferably, the device according to the invention comprises a monitoring, measuring and control device, wherein the monitoring and/or control device is designed in such a way that sensor values (e.g. for the pressure in the reactor, for one or more temperatures in the reactor, for the inlet and outlet temperature of a heat transfer fluid and for its volumetric flow, as well as the power consumption and/or for a current flow through the inductor, etc.) are detected and evaluated in order to monitor and/or control the function of the device, in particular the output power and the efficiency.

### Description of Exemplary Designs

### Reactor

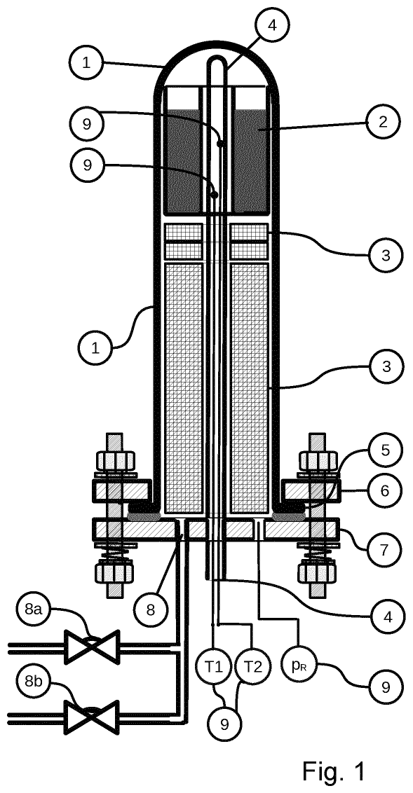

The apparatus according to the invention comprises a reactor 1, which consists of a lockable vessel as shown in FIGS. 1, 4, 5 and 6. In the closed state, the reactor is gas-tight in such a way that an ultra-high vacuum can be generated in it, which remains for a long time even after the vacuum pump has been disconnected. An ultra-high vacuum is understood to be a pressure of less than 10-5 Pa. This is achieved by making the walls of the reactor, the reversible closure and the connections gas-tight in an efficient manner.

The reactor has an opening that can be closed, for example, with a blind flange. This allows the reactor 1 to be reversibly opened in order to introduce reaction material (see below) into the reactor or to replace it with another.

FIGS. 1, 4, 5 and 6 show the reactor with a closed closure. The closure is designed as a blind flange 7 with flange ring 5, 6 and clamping screws. Alternatively, the blind flange can also be tightly sealed with other types of closure, for example as a screw closure, by means of a KF flange with clamping ring or with a bayonet closure.

Preferably, the reactor 1 is formed as a container made of a heat-resistant material which must be induction-permeable, such as quartz glass or ceramics, in particular in the form of a tubular container made of such a material. Preferably, the reactor 1 is formed by a tubular container arranged upright in operation, the lower end of which is closed off with closure 5, 6, 7. This construction allows a temperature profile in which high temperatures prevail in the upper area of the reactor, while the lower area, in which the closure, connections for gas exchange and feed-throughs for pressure and temperature sensors are located, is at ambient temperature. This means that both the seal and the feedthroughs for sensors are not exposed to unfavourable temperature changes. Optionally, the displacement and insulation body can be designed as a cavity connected to the outside space.

### Closure, Connections

The closure has a connection 8 for a gas exchange. A gas supply line and/or a vacuum line can be connected to the connection for gas exchange. Preferably, valves 8a and 8b are provided with which the connection can be shut off and thus made gas-tight. The connection 8 can optionally be made via valve 8a with a reaction gas from a gas cylinder (pressure vessel) 16 or via valve 8b to a vacuum device 17.

Alternatively, the connection 8 can also be arranged in the area of the remaining reactor wall instead of in the area of a closure. It is also possible that the reactor has several connections, for example separate connections for a gas supply line and a vacuum line.

A pressure sensor 10 may be led through the blind flange 7 or another area of the reactor wall into the interior of the reactor in order to measure and register the pressure pR inside the reactor. The pressure sensor can also be arranged in the area of the connection for the gas exchange, for example on the side of the valves 8a, resp. 8b facing the inside of the reactor.

### Temperature Sensors

One or more temperature sensors 9 can be led through the closure 7 or another area of the reactor wall into the interior of the reactor. Preferably, the temperature probes 9 are located in a tube 4 arranged centrally in the interior of the reactor. This is closed off at the top but open to the atmosphere at the bottom. This arrangement allows temperature sensors, preferably thermocouples, to be adjusted during operation of the device in order to measure the temperature at different points inside the reactor. Calibration measurements confirm that the temperature measurement with thermocouples, for example of type K, is not affected by the induction field in this arrangement.

### Reaction Material, as Variants in Solid and in Powder Form

The reaction material used is in particular a metallic, electrically conductive material, preferably palladium (Pd) and/or nickel (Ni) and optionally lithium (Li), in particular high-purity Ni or Pd and/or a mixture with Pd and/or Ni and/or Li. The alloy may comprise, for example, at least one neutron-absorbing element, such as boron, lithium, niobium, vanadium. Other, for example amorphous, hydrogen-storing metals, in particular hydrogen-storing alloys, can also be used as reaction material. Optionally, the reaction material has an enlarged surface. Such a surface can preferably be achieved as a fine powder as listed below, or by roughening the surface, by pores contained in the reaction material, a coating, in particular an electroplating, or an acid treatment, etc. Likewise, the reaction material can be given a more active surface by embrittlement by means of hydrogen treatment. Furthermore, it can be nanostructured particles, as described by Beiting 2017, among others (Beiting, Edward. 2017. “Investigation of the Nickel-Hydrogen Anomalous Heat Effect. ATR-2017-01760. Propulsion Science Department: Aerospace Corporation, May 2017). Optionally, the reaction material has a doping, i.e. it consists of a base material (e.g. Ni or Ni alloy) and a minor admixture (e.g. Pd et al. in the % or ppm range), which in particular have some catalytic effect, as described by Mizuno et al (Mizuno, T. and J. Rothwell. 2019. “Increased Excess Heat from Palladium Deposited on Nickel (preprint).” 22nd International Conference for Condensed Matter Nuclear Science ICCF-22. Assisi, Italy, 2019.)

The reaction material 2, which is to be loaded with the reaction gas, is arranged inside the reactor 1, preferably positioned in the optimum region of the induction field by a support structure 3. It has an annular or hollow cylindrical shape. The annular shape can be realized, for example, in the following ways: the reaction material is present as an annular solid or from a stack of several annular solids, for example a stack of annular discs and/or wire loops. The solid or solids may, for example, be cast or formed into annular shape by a forming process or stamping. Alternatively, the reaction material may be a sponge metal body or a sintered body (or a plurality of sponge metal bodies or sintered bodies joined together).

Alternatively, the reaction material may be a fine-grained, pressed or binder-bonded powder or powder mixture arranged hollow-cylindrically in an annular gap between two concentrically arranged cylinder shell surfaces or a similar support structure. The powder mixture can be placed between metal rings below and above it to optimize inductive heating, but can also be divided into layers by several electrically conductive rings. The powder mixture may contain a hydrogen source, preferably in the form of LiAlH4 (as described below). Iron powder can also be added to improve the electrical properties of the reaction material. Raney nickel treated under hydrogen can be used as a further active reaction material.

### Inductor: Embodiments 1 and 2 (Conventional and Dynamic Insulation)

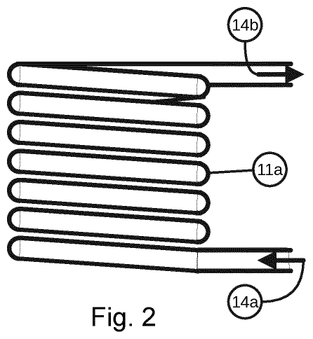

The inductor 11 (11a, 11b) is formed as a coil of an electrically conductive material surrounding at least a section of the reactor. The coil preferably has at least one to several windings. In the examples shown in FIGS. 2, 4, 5 and 6, the coil has seven turns. Alternatively, a larger or smaller number of turns is possible.

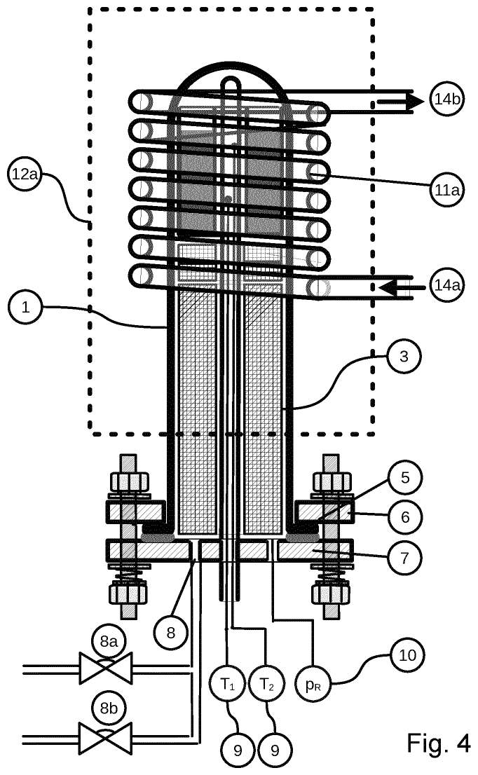

The reaction material 2 (2a, 2b) and the inductor 11 (11a, 11b) are arranged such that the reaction material is heated and stimulated by applying an AC voltage to the inductor so that a low energy nuclear reaction is initiated with a reaction gas supplied to the reactor. The inductor thus serves to excite and maintain the reaction. The preferably circular cylindrical reaction material 2 represents a closed secondary conductor in which induction takes place by means of the inductor 11 (primary coil) in order to heat and stimulate the reaction material 2. The arrangement of the coil 11a (also 11b) surrounding the upper region of the reactor 1 is shown in FIG. 4.

In the first embodiment example, the inductor 11a is formed of a tube with an electrically conductive wall, for example of copper or aluminium. In this embodiment, the inductor 11a serves both for induction and for dissipation of thermal energy emitted by the reactor. For this purpose, a heat transfer fluid is passed through the tube, which is indicated in FIGS. 2, 4 and 6 by the arrows 14a—inlet—and 14b outlet of the heat transfer fluid. The heat transfer fluid can be a liquid or a gas. The temperatures TIN and TOUT of the incoming and outgoing heat transfer fluid can be measured with sensors and the amount of heat dissipated can be determined from the temperature difference and the volume flow.

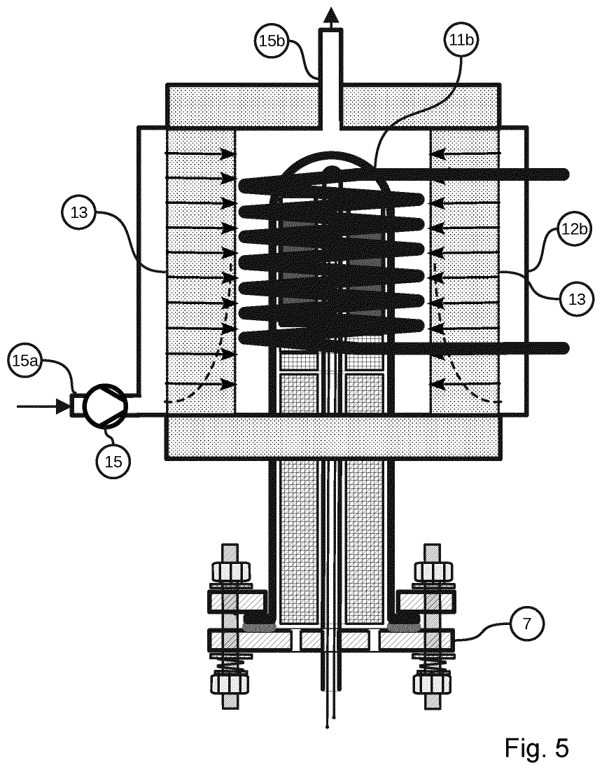

As sketched in FIGS. 4 and 5, insulation 12a and 12b respectively is provided to thermally insulate parts of the device or the device as a whole from the environment. The pipes for the heat transfer fluid can be led through the insulation. The insulation and the principle of heat dissipation are described in a first and a second embodiment (static or dynamic insulation).

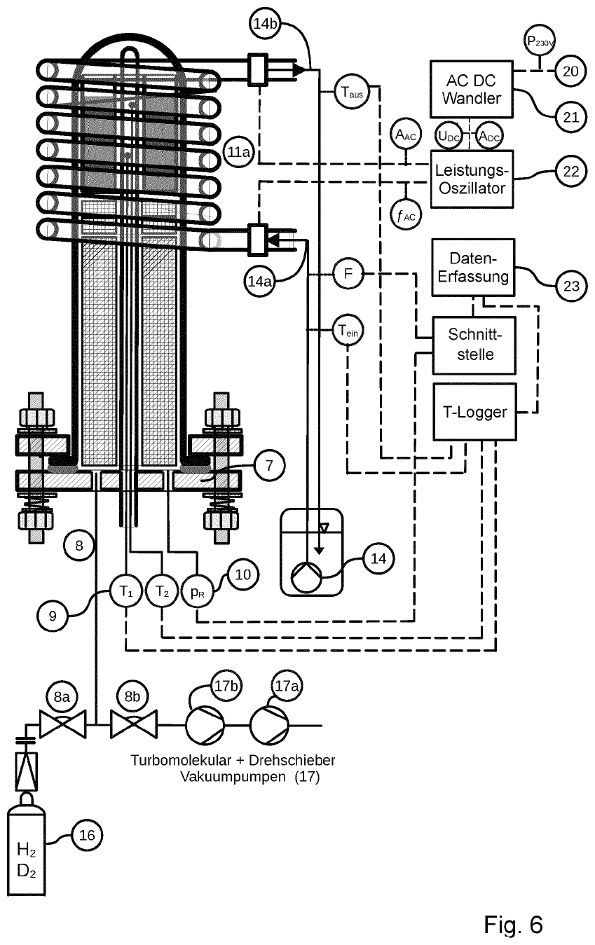

FIGS. 4 and 6 sketch a first embodiment. FIG. 6 shows a circuit for the heat transfer fluid, comprising a storage vessel and pump 14. The heat given off by the reactor can be decoupled from this fluid. A heat exchanger for extracting the useful energy is not shown. Instead of such a circuit, any device can be provided with which thermal energy can be generated and used. Instead of heat removal by means of heat transfer fluid, another form of heat utilisation may be used in this and other embodiments, for example electricity generation by means of a Stirling engine, steam turbine, organic Rankine cycle ORC or combined heat and power generation.

FIG. 5 illustrates a second embodiment example of the present invention, preferably using dynamic insulation for moderated heat removal. This differs from the first example in the design of the insulation and the heat dissipation device. The other components correspond to those of the device according to the first design example, so that reference is made to its description above. According to the second design example, no heat transfer fluid flows through the inductor 11a. In this case, the inductor 11b may comprise an electrical conductor that does not have a tubular cavity. For example, it may be a solid copper conductor. According to the second embodiment example, at least a section of the reactor 1 is surrounded by a heat transfer fluid 15 for heat dissipation. Excessive cooling may cause the reaction to stop. Therefore, a moderated heat removal by a minimal internal insulation or gas as heat transfer fluid can be advantageous. This has also been found by Mizuno et. al (Mizuno, T. and J. Rothwell: “Experimental Procedures for Excess Heat Generation from Cold Fusion Reactions”. In Cold Fusion, Chapter 8, ed: J.-P. Biberian, 115-156. Elsevier, Jan. 2020).

Dynamic insulation is a form of insulation in which an insulation layer 13 has a heat transfer fluid 15 flowing radially through it from the outside to the inside. The heat transfer fluid is preferably a gas, for example air, but can also be a liquid. In this case, the heat insulation is designed as a fluid-permeable layer 13 within a dense outer insulation jacket. The heat emitted by the reactor heats the gas-permeable insulation material 13 and thus the fluid flowing in counter current. The temperature in the insulation jacket increases from the outside to the inside (e.g. exponentially) and reaches a maximum temperature at the fluid outlet on the inside of the insulation material. In the insulation layer, a balance is established between radiation of the reaction material 2 and the convective counterflow of the heat transfer fluid 15, so that this insulation layer insulates almost loss-free, even if it is porous and relatively thin. The U-value varies with the velocity of the gas flowing through the insulation and can reach the value 0 (e.g. 0.05 Wm-2 K-1). Due to this principle, the outside temperature is close to the ambient temperature, in particular a maximum of approx. 30 K above the ambient temperature. The heated fluid, e.g. air, is fed via a collecting pipe or via several collecting pipes to a use, e.g. via a heat exchanger for thermal use, as mentioned above.

According to a third embodiment of the invention not shown in the figures, both described types of heat removal are combined, i.e. one heat transfer fluid flows through the tubular inductor and a second heat transfer fluid flows around at least a section of the reactor.

The reaction in the reactor can be stopped by switching off the inductive heating. The second embodiment can be equipped with an emergency shutdown as a supplement. For this purpose, the heat flow from the counter current in the insulation can be reversed to direct current. This causes the insulation layer to lose its effect. Alternatively, the gap between insulation 13 and inductor 11b can be opened on both sides and flowed through by ambient air. This brings the reactor below the critical temperature even more quickly, so that the heat generation comes to a standstill.

FIG. 6 shows by way of example that the drive energy 20 is supplied from the mains via a rectifier 21 to a power oscillator 22. The power oscillator 22 is connected to the inductor 11 and supplies the alternating voltage or current with which the inductor 11 (11a or 11b) is operated in order to generate an alternating field inside the reactor 1.

The data acquisition device 23, together with sensors and optional further peripheral electronic devices (e.g. monitor), forms the monitoring and/or control device of the apparatus according to the invention. FIG. 6 shows how the temperatures measured with sensors and further measured values, such as reactor pressure and volume flows, are fed into a data acquisition device 23. The monitoring and/or control device may comprise a computer running suitable software, for example Lab View, ProfiLab Expert, a comparable commercial application or specially programmed software. The measurement and control signals from sensors and actuators are integrated via appropriate interfaces or transmitters.

The preparation of the reaction material can take several days. In order to excite and maintain a low-energy nuclear reaction for the generation of thermal energy, in particular in a device according to the present invention, the following procedure has proven to be advantageous:

Nickel powder of 1-5 g with grain sizes around 40-100 μm and finer, metal foils with thicknesses between 0.01-0.5 mm or metal foam, 5 mm thick cut out into rings and stacked are used, for example.

The reaction material is cleaned and conditioned by repeated thermal treatments under high vacuum, initially at room temperature and repeated at 500-600 K for several cycles of typically 8 hours.

Introduction of reaction gas at approx. 50-100 kPa and repetition of several adsorption cycles. The temperature is preferably maintained at 450-600 K.

Alternate addition of hydrogen within 24 hours up to approx. 105 Pa must be repeated several times (e.g. about 10-15 times). Through this alternating exposure, the reaction material can become brittle and thus obtain a more active surface on which so-called nuclear active environments nae can form. Other sources mention the direct use of nanoparticles or clusters (e.g. Piantelli, Francesco. 2017. Method for Producing Energy and Apparatus therefore US2017038095A1, published 9 Feb. 2017).

Hydrogen is used with a purity of 99.9% or higher, or deuterium.

Alternatively, hydrogen can be introduced by means of lithium aluminium hydride LiAlH4. Lithium can act as an essential reactant in the reaction mixture. In this bound form, the exact mass fraction of hydrogen is precisely defined. Through thermal decomposition, hydrogen is released in three temperature steps between 400 and 900 K and adsorbed by the reaction material. This process is pressure controlled. This process can take several days. Andrea Rossi, Leonardo Corp. Miami, USA used lithium aluminium hydride (LiAlH4) at 10% in the mixture (see e.g. Levi, G., et. al.: “Observation of Abundant Heat Production from a Reactor Device and of Isotopic Changes in the Fuel”. Preprint University of Bologna, IT, 6 Oct. 2014. or I. N. Stepanov, Yu. I. Malahov, and C. N. Quoc: “Experimental Measurement of Excess Thermal Energy Released from a Cell Loaded with a Mixture of Nickel Powder and Lithium Aluminum Hydride”. Journal of Emerging Areas of Science, translated from Russian by Higgins B. In general, nickel to LiAlH4 mixing ratios of 1 to 0.1 were used. To favour the present inductive heating, a 40% content of Fe powder in the mixture can increase the conductivity.

The reaction material is inductively heated by applying an alternating magnetic field to the reaction material. The power consumption of the inverter is in the range of 20 watts DC in order to achieve reaction temperatures around 300° C. The efficiency is significantly higher than that of the inverter. The efficiency is significantly higher than that of the sources cited above. The induction and excitation frequency is in the range of 30-100 kHz, but can be much lower but also higher frequencies up to the MHz range. The frequency must be adapted to the respective reaction material in order to achieve an optimal resonance in the oscillating circuit. Power control by means of pulse width modulation leads to stochastic harmonic fields, which can be important for excitation.

The onset of abnormal heat generation can be stimulated by temperature jumps, pressure pulses or frequency changes, but can also occur spontaneously at constant input after a longer period of exposure and be recognised by an immediate temperature increase.

The apparatus and method according to the invention have a very wide field of application. The apparatus and the process can be scaled as desired, from micro-scale to small units to modularly constructed large-scale plants, from private to commercial to large-scale industrial applications. The apparatus concept and the process are used, for example, in building technology for heating and air-conditioning buildings, for transport with vehicle and ship drives, for process heat and for electricity generation, and even for seawater desalination and drinking water treatment. In addition to CO2-free energy generation, safety and economic efficiency are particularly important. In particular, there are no radioactive emissions and no disposal problems; there is no need for final storage.

1. A device for obtaining thermal energy by means of a low-energy nuclear reaction, the device comprising:
a tubular reactor configured to receive a metallic reaction material and inductively heat the reaction material, the reactor comprising an electrically insulating and induction-permeable material, wherein the induction-permeable material is one of glass, quartz glass, or ceramics;
a closure that can be sealed in a vacuum-tight manner and configured to permit introduction and exchange of different metallic reaction materials;
a gas exchange connection for evacuation and introduction of reaction gas;
one or more sensors to measure temperature or pressure in an interior of the reactor; and
an inductor for generating an alternating magnetic field in the interior of the reactor;
wherein the reaction material can be inductively heated by applying an alternating voltage to the inductor, the closure, and the gas exchange connection.

2. The device according to claim 1, wherein the closure is configured as a blind flange, having one or more flange rings, wherein the reactor is sealed in the vacuum-tight manner when the closure is closed and allows exchange of the reaction material when the closure is open, wherein the closure is closed by means of the one or more flange rings and clamping screws, and wherein the gas exchange connection is arranged on the blind flange and the one or more sensors are guided through the closure.

3. The device according to claim 1, the device further comprising:
a pressure vessel connected or connectable to the gas exchange connection the and including a reaction gas; and
a vacuum device connected or connectable to the gas exchange connection;
wherein the reaction gas comprises hydrogen or a gas mixture containing hydrogen, wherein the hydrogen or the gas mixture includes one or more hydrogen isotopes, wherein the one or more hydrogen isotopes includes protium or deuterium.

4. The device according to claim 1, wherein the one or more sensors include at least two sensors for measuring temperatures in the interior of the reactor, wherein the at least two sensors are each configured to measure temperature at different locations in the interior of the reactor, and wherein the one or more sensors include a pressure sensor for measuring pressure in the interior of the reactor.

5. The device according to claim 1, wherein the reaction material is electrically conductive and includes nickel or palladium or lithium, and wherein the reaction material is formed as a spiral wrap or has an annular shape comprising one annular solid or several stacked annular solids.

6. The device according to claim 1, wherein the reaction material has a porous or roughened surface, wherein the reaction material has a galvanic coating, and wherein the reaction material is doped.

7. The device according to claim 1, wherein the reaction material is arranged as a free-flowing, bound, or compacted powder or powder mixture formed as a hollow cylinder in an annular gap or between carrier rings.

8. The device according to claim 1, wherein the inductor is a coil surrounding at least one section of the reactor and includes an electrically conductive material, and wherein the coil is a cylindrical coil with several windings capable of being stimulated by the alternating voltage applied to the inductor so that a low-energy nuclear reaction takes place.

9. The device according to claim 8, wherein the coil is formed as a coiled tube configured to serve as an inductor and for heat dissipation, and wherein a heat transfer fluid flowing through the coil tube can dissipate heat given off by the reactor.

10. The device according to claim 9, wherein the reactor is at least partially surrounded by a dynamic insulation in which the heat transfer fluid flows radially from an interspace of a gas-tight outer shell through a gas-permeable layer against an outer wall of the reactor and is discharged through at least one collecting channel.

11. The device according to claim 1, the device further comprising:
an induction generator formed as a power oscillator (22), wherein the power oscillator is configured to supply the inductor with an alternating current, wherein the induction generator can be controlled or regulated with pulse width modulation, wherein the induction generator is configured to provide a pulsed alternating current, and wherein the induction generator provides an alternating current superimposed with harmonics.

12. The device according to claim 11, the device further comprising:
a monitoring or control device configured to detect sensor values for at least one pressure in the reactor, temperatures in the reactor, inlet and outlet temperatures of heat transfer fluid, temperatures of a volumetric flow of the heat transfer fluid, and power consumption of the power oscillator.

13. (canceled)

14. A method of recovering or generating thermal energy in a low-energy nuclear reaction, the method comprising:
placing a reaction material in a reactor that is configured to be sealed in a vacuum-tight manner;
cleaning the reaction material under high vacuum;
introducing a reaction gas in several cycles at temperatures above 430 K and under low pressure up to a maximum of 105 Pa;
heating the reaction material by introducing an alternating magnetic field on the reaction material;
dissipating thermal energy emitted by the reactor by via a tubular inductor by means of a dynamic insulation.

15. A method for treating a metallic material by a transmutation in a low-energy nuclear reaction conducted in an apparatus comprising a reactor configured to receive the metallic material and inductively heat the metallic material, a closure configured to permit introduction and rapid exchange of different metallic reaction materials, a gas exchange connection, at least one sensor configured to measure temperature or pressure in an interior of the reactor, and an inductor configured to generate an alternating magnetic field in the interior of the reactor, the method comprising:
placing the metallic material in the reactor that is configured to be sealed in a vacuum-tight manner;
cleaning the metallic material under high vacuum;
introducing a reaction gas in several cycles at temperatures above 430 K and under low pressure up to a maximum of 105 Pa;
heating the metallic material by introducing an alternating magnetic field on the metallic material; and
dissipating thermal energy emitted by the reactor by means via a tubular inductor by means of a dynamic insulation.
